(19) United States
(12) Patent Application Publication
(10) Pub. No.: US 2017/0282410 A1
(43) Pub. Date: Oct. 5, 2017

(54) PRODUCTION PROCESSING AID

(71) Applicant: FINA TECHNOLOGY, INC., Houston, TX (US)

(72) Inventors: Michael Allen MCLEOD, Houston, TX (US); Jon TIPPET, League City, TX (US); Leonardo Cortes RODRIGUEZ, League City, TX (US); John ASHBAUGH, Houston, TX (US); Marc MAYHALL, Pearland, TX (US)

(21) Appl. No.: 15/087,747

(22) Filed: Mar. 31, 2016

(51) Int. Cl. B29B 9/12; B29B 9/10; B29C 51/00; B29C 47/00; B29C 49/00; C08K 5/098; B29C 45/00

(52) U.S. Cl. CPC B29B 9/12; C08K 5/098; B29B 9/10; B29C 45/0001; B29C 47/0004; B29C 49/0005; B29C 51/002; B29K 2023/12

(57) ABSTRACT

A process includes contacting a metallic acrylic salt with a polyolefin, forming a polyolefin composition. The process includes extruding the polyolefin composition, and pelletizing the extruded polyolefin composition. A production rate of pellets of the polyolefin composition may be equal to or greater than a production rate of pellets of the polyolefin prior to contact with the metallic acrylic salt without increasing extrusion pressure or motor amperes. The polyolefin composition may have a melt flow rate that is lower than the melt flow rate of the polyolefin prior to contact with the metallic acrylic salt. The metallic acrylic salt may only be contacted with the polyolefin to form the polyolefin composition during a start-up of an extruder and pelletizer.

### CROSS-REFERENCE TO RELATED APPLICATIONS

Not applicable.

### FIELD

Embodiments of the present disclosure generally relate to use of processing aids in polymer extrusion and pelletization processes. More particularly, embodiments of the present disclosure relate to use of metallic acrylic salts as processing aids in polyolefin extrusion and pelletization processes.

### BACKGROUND

Polyolefins are often processed by extrusion and pelletization. Traditionally, commercial polyolefin production has limitations in steady-state plant-scale extrusion processing, such as when the viscosity of a polyolefin is either very low or very high, which compromises the ability to pelletize such polyolefin at commercial production rates. Extruder pressures or motor amperes used during extrusion of a polyolefin may exceed equipment tolerance if the viscosity is too high. Further, pellet consistency may suffer for the pelletized polyolefin having either too low or too high a viscosity, resulting in a variety of different pellet sizes and pellet defects. Poorer pellet cuts leads to increased loss as pellets pass through classifiers in which the largest and smallest pellets are excluded from the prime pellet cut stream.

Another limitation in traditional polyolefin processing is in transient plant-scale extrusion at the start-up of polyolefin extrusion. For example, start-up of underwater pelletization of high melt flow rate polyolefin resins presents challenges due to the potential to smear the resin melt as it is initially exiting the die of the extruder. Such smearing, rather than forming pellets, may cause the resin melt to congeal around the cutting blades of the underwater pelletizer. Congealing of the resin melt around the cutting blades can produce an intractable mass of the resin, which may require an immediate shutdown of the underwater pelletizer and additional downtime to clear the die face and cutting blades.

Transient plant-scale extrusion issues can occur in strand pelletization. In strand pelletization, the lack of melt strength of higher melt flow rate polyolefin resins can adversely affect the stringing up of strands as the extruded strands move through a water bath and into a pelletizer. In such strand pelletization processes, there can be the tendency for draw resonance to occur, wherein a diameter of the strands varies along the length of the strand. Pelletization of strands exhibiting draw resonance can result in the formation of pellets with irregular pellet diameters, which impacts strand cutting and strand cut quality. Strand pelletization of lower melt flow rate polyolefin resins can exhibit extreme die swell, causing the extruded strands to stick together. Strand pelletization of lower melt flow rate polyolefin resins can also exhibit little elastic recovery, causing the extruded strands to break, as well as heavy melt fracture, causing water carry-over. As with underwater pelletization, such problems add cost due to increased scrap, increased downtime, and reduced quality.

Pellet cut inconsistency can also create problems on processing equipment, such as smaller sized extrusion and injection molding lines. Irregular pellet sizes can have a negative impact on such processing equipment, including surging due to irregular pellet feeding, bridging in hoppers, unmelts, poor color dispersion in the resin, and throughput limitations. If pellet cut is sufficiently irregular, the irregular pellets often have to be off-graded for failure to meet minimum quality requirements.

### SUMMARY

The present disclosure provides for a process. The process includes contacting a metallic acrylic salt with a polyolefin to form a polyolefin composition. The process includes extruding the polyolefin composition, and pelletizing the extruded polyolefin composition. The polyolefin composition has a melt flow rate, as measured according to ASTM D 1238 standard at 230° C. under a load of 2.16 kg, that is lower than the melt flow rate of the polyolefin prior to contact with the metallic acrylic salt.

The present disclosure also provides for a start-up process. The start-up process includes contacting a metallic acrylic salt with a polyolefin, forming a polyolefin composition. The process includes extruding the polyolefin composition, and pelletizing the extruded polyolefin composition. The metallic acrylic salt is only contacted with the polyolefin to form the polyolefin composition during a start-up of an extruder and pelletizer.

The present disclosure provides for another process. The process includes contacting a metallic acrylic salt with a polyolefin to form a polyolefin composition. The process includes extruding the polyolefin composition, and pelletizing the extruded polyolefin composition. A production rate of pellets of the polyolefin composition is equal to or greater than a production rate of pellets of the polyolefin prior to contact with the metallic acrylic salt without increasing extrusion pressure or motor amperes, notwithstanding the final lower melt flow rate of the polyolefin composition in comparison to the melt flow rate of the polyolefin prior to contact with the metallic acrylic salt.

### BRIEF DESCRIPTION OF DRAWINGS

The present disclosure may be understood from the following detailed description when read with the accompanying figures.

FIGS. 1A-1N depict various polymeric pellets in accordance with certain embodiments of the present disclosure.

FIG. 2A is a flow diagram of an extrusion and pelletization process in accordance with certain embodiments of the present disclosure.

FIG. 2B is a flow diagram of an extrusion and pelletization process with a cooling section in accordance with certain embodiments of the present disclosure.

FIG. 2C is a flow diagram of a compounding process in accordance with certain embodiments of the present disclosure.

FIG. 3 is a graph of melt flow rate versus concentration of zinc diacrylate in accordance with Example 1 of the present disclosure.

### DETAILED DESCRIPTION

A detailed description will now be provided. The following disclosure includes specific embodiments, versions and examples, but the disclosure is not limited to these embodiments, versions or examples, which are included to enable a person having ordinary skill in the art to make and use the disclosure when the information in this application is combined with available information and technology.

Various terms as used herein are shown below. To the extent a term used in a claim is not defined below, it should be given the broadest definition persons in the pertinent art have given that term as reflected in printed publications and issued patents. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Where numerical ranges or limitations are expressly stated, such expressed ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

Certain embodiments of the present disclosure relate to a process. The process includes contacting a metallic acrylic salt with a polyolefin. Contacting the metallic acrylic salt with the polyolefin forms a polyolefin composition. In some embodiments, contacting the metallic acrylic salt with the polyolefin includes compounding the metallic acrylic salt with the polyolefin. For example and without limitation, contacting the metallic acrylic salt with the polyolefin may include melt mixing the metallic acrylic salt with the polyolefin. In some embodiments, contacting the metallic acrylic salt with the polyolefin includes shearing, mixing, heating, or combinations thereof. For example and without limitation, the polyolefin may be brought to a molten state, and the metallic acrylic salt may be mixed with the molten polyolefin. The metallic acrylic salt may be mixed with the polyolefin prior to or after the polyolefin is brought to the molten state. In some embodiments, the metallic acrylic salt and polyolefin may be mixed until the metallic acrylic salt is homogenously distributed within the molten polyolefin.

The metallic acrylic salt may be present in the polyolefin composition in an amount ranging from greater than 0 weight percent to 10 weight percent, from 0.01 weight percent to 8 weight percent, from 0.05 weight percent to 5 weight percent, from 0.1 weight percent to 3 weight percent, or from 0.5 weight percent to 2.5 weight percent, each based on a total weight of the polyolefin composition.

Non-limiting examples of metallic acrylate salts are metallic diacrylates, such as zinc diacrylate, zinc dimethylacrylate, copper diacrylate, copper dimethylacrylate, or combinations thereof. Examples of commercially available metallic acrylate salts suitable for use in some embodiments of the present disclosure are DYMALINK® 9200 or DYMALINK® 9201, both of which are commercially available from Total Cray Valley. DYMALINK® 9200 is a zinc acrylate available as a white powder having a molecular weight of about 207 g/mol. DYMALINK® 9201 includes the metallic diacrylate included in DYMALINK® 9200 in a pellet concentrate that additionally contains an elastomeric binder system.

The polyolefin may be present in the polyolefin composition in an amount ranging from greater than 80 weight percent to less than 100 weight percent, from 85 weight percent to 99.9 weight percent, from 90 weight percent to 99 weight percent, from 92 weight percent to 98 weight percent, or from 95 weight percent to 99.9 weight percent, each based on the total weight of the polyolefin composition. In some embodiments, the polyolefin may be present in the polyolefin composition in an amount ranging from 99.25 weight percent to 97.75 weight percent, or 98.75 weight percent to 98.25 weight percent, each based on the total weight of the polyolefin composition.

In some embodiments, the polyolefin is a polypropylene. In certain embodiments, the polypropylene contains at least 50 weight percent, at least 70 weight percent, at least 75 weight percent, at least 80 weight percent, at least 85 weight percent, at least 90 weight percent, at least 95 weight percent, at least 99 weight percent, or 100 weight percent polypropylene relative to the total weight of the polyolefin.

In some embodiments, the polypropylene may be, for instance, a propylene homopolymer, a propylene random copolymer, a propylene impact copolymer, a syndiotactic polypropylene, an isotactic polypropylene or an atactic polypropylene. In other embodiments, the polypropylene may be a “mini-random” polypropylene. A mini-random polypropylene has less than about 1.0 weight percent of comonomer. In certain embodiments, the comonomer in the mini-random polypropylene is ethylene.

In some embodiments, the polyolefin is a polyethylene. In certain embodiments, the polyethylene contains at least 50 weight percent, at least 70 weight percent, at least 75 weight percent, at least 80 weight percent, at least 85 weight percent, at least 90 weight percent, at least 95 weight percent, at least 99 weight percent, or 100 weight percent polyethylene relative to the total weight of the polyolefin.

In some embodiments, the polyethylene may be a polyethylene homopolymer or a polyethylene copolymer. In certain embodiments, the polyethylene is a low density polyethylene, a medium density polyethylene, or a high density polyethylene. As used herein “low density polyethylene” has a density of 0.925 g/cm³ or less, or ranging from 0.880 to 0.925 g/cm³; “medium density polyethylene” has a density ranging from 0.926 to 0.940 g/cm³; and “high density polyethylene” has density of 0.941 g/cm³ or greater, or ranging from 0.941 to 0.970 g/cm³. In certain embodiments, the polyethylene is a linear low density polyethylene or a very low density polyethylene. As used herein “linear low density polyethylene” has a density ranging from 0.916 to 0.925 g/cm³; and “very low density polyethylene” has a density ranging from 0.890 to 0.915 g/cm³. Unless otherwise stated, the densities of the polyethylene disclosed herein are determined in accordance with ASTM D 792.

In some embodiments, the polyolefin is a polyolefin homopolymer or copolymer other than polypropylene or polyethylene. For example and without limitation, the polyolefin may be a C₄-C₁₀ alpha olefin homopolymer or copolymer. Such a polyolefin may contain at least 50 weight percent, at least 70 weight percent, at least 75 weight percent, at least 80 weight percent, at least 85 weight percent, at least 90 weight percent, at least 95 weight percent, at least 99 weight percent, or 100 weight percent C₄-C₁₀ alpha olefin monomeric units relative to a total weight of the polyolefin.

In some embodiments, the polyolefin is an olefinic-based elastomer. The olefinic-based elastomer may be an ethylene α-olefin copolymer, such as an ethylene-butene or ethylene-octene copolymer, for example.

In some embodiments, the polyolefin contains polypropylene, polyethylene, polyolefin other than polypropylene and polyethylene, olefinic-based elastomer, or combinations thereof.

In some embodiments, the polyolefin is a reactor grade polyolefin. As used herein, “reactor grade polyolefin” refers to polyolefin in the form of a powder, granules, or fluff. Reactor grade polyolefin may be obtained directly from a polymerization reactor in which the polyolefin is produced, optionally without any further processing prior to contacting the metallic acrylic salt.

In certain embodiments, the polyolefin is a metallocene-catalyzed polyolefin. As used herein, “metallocene-catalyzed” polyolefin refers to polyolefin produced in the presence of a metallocene-based catalyst system. In other embodiments, the polyolefin is a Ziegler-Natta-catalyzed polyolefin. As used herein, “Ziegler-Natta-catalyzed” polyolefin refers to polyolefin produced in the presence of a Ziegler-Natta-based catalyst system.

In some embodiments, the polyolefin composition contains one or more additives other than the metallic acrylic salt. The additives may include stabilizers, lubricants, clarifiers, acid neutralizers, additives for radiation resistance, ultraviolet screening agents, oxidants, antioxidants, anti-static agents, ultraviolet light absorbents, fire retardants, anti-blocks, coefficient of friction modifiers, processing oils, mold release agents, coloring agents, pigments, nucleating agents, fillers, or combinations thereof, for example.

The process includes melt extruding the polyolefin composition. For example and without limitation, melt extrusion of the polyolefin composition may be performed using an extruder, such as a single screw or twin screw extruder. For example and without limitation, the polyolefin, metallic acrylic salt, and optional one or more additives other than the metallic acrylic salt may be fed through a hopper of an extruder into a barrel of the extruder. Within the barrel of the extruder, the polyolefin, metallic acrylic salt, and optional one or more additives other than the metallic acrylic salts may be melted and mixed, forming the polyolefin composition. In some embodiments, the metallic acrylic salt is mixed with the polyolefin prior to entry into the extruder, such as in a BANBURY® mixer or a roll mill. The screw(s) of the extruder may force the molten polyolefin composition into and through a die of the extruder. The molten polyolefin composition may exit the die of the extruder.

The process includes pelletizing the extruded polyolefin composition. In some embodiments, the process includes strand pelletizing the extruded polyolefin composition. In strand pelletizing the extruded polyolefin composition, strands of the molten polyolefin composition exit the die of the extruder and are cooled prior to being pelletized. The strands of the molten polyolefin composition may be cooled by passing the strands through a water bath that is colder than the strands, by contact with air that is colder than the strands, or combinations thereof. After cooling, the strands may be pelletized by a pelletizer. For example and without limitation, a knife of the pelletizer may cut the strands into pellets after the strands are cooled.

In some embodiments, the process includes melt pelletizing the extruded polyolefin composition. In melt pelletization, rather than forming strands and cooling the strands, the extruded polyolefin composition is cut into pellets via a pelletizer as the extruded polyolefin bend exit the die of the extruder. In such embodiments, the extruded polyolefin composition is not cooled after extrusion and prior to pelletization. For example and without limitation, a knife may cut the extruded polyolefin composition into pellets as the extruded polyolefin composition exits the extruder through the die hole.

In some embodiments, the extruded polyolefin composition is pelletized using an underwater pelletizer. In underwater pelletization, as the extruded polyolefin composition exits the die hole of the extruder, the extruded polyolefin composition is underwater. An underwater knife may cut the extruded polyolefin composition into pellets as the extruded polyolefin composition exits the extruder through the die hole.

In some embodiments, the process exhibits an increase in production rate of pellets in comparison to the production rate of pellets exhibited by a composition of equivalent melt flow rate without the metallic acrylic salt. In some embodiments, the process exhibits an increased production rate of prime pellets. Without being bound by theory, it is believed that addition of a metallic acrylic salt to a polyolefin offers the ability to increase output of a pelletized polyolefin. For example and without limitation, an amount in weight of pelletized polyolefin produced per unit of time may be higher for a polyolefin composition in comparison to an amount in weight of pelletized polyolefin produced per unit of time of a polyolefin of the same or similar melt flow rate that does not contain the metallic acrylic salt.

Additionally, without being bound by theory, it is believed that addition of a metallic acrylic salt to the polyolefin may result in an increased amount in weight of prime pellets produced per unit of time in comparison to an amount in weight of prime pellets produced per unit of time of a polyolefin of the same or similar melt flow rate without the metallic acrylic salt.

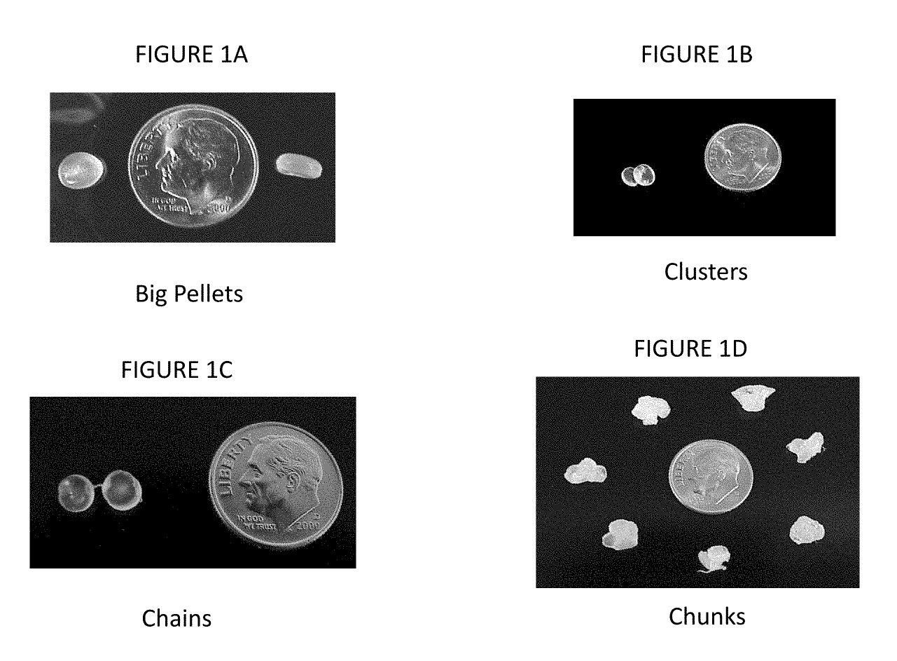

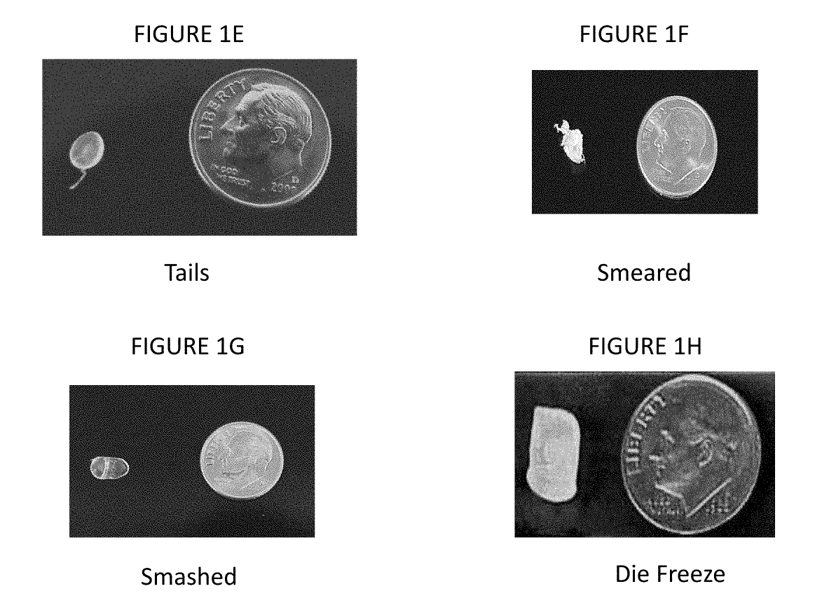

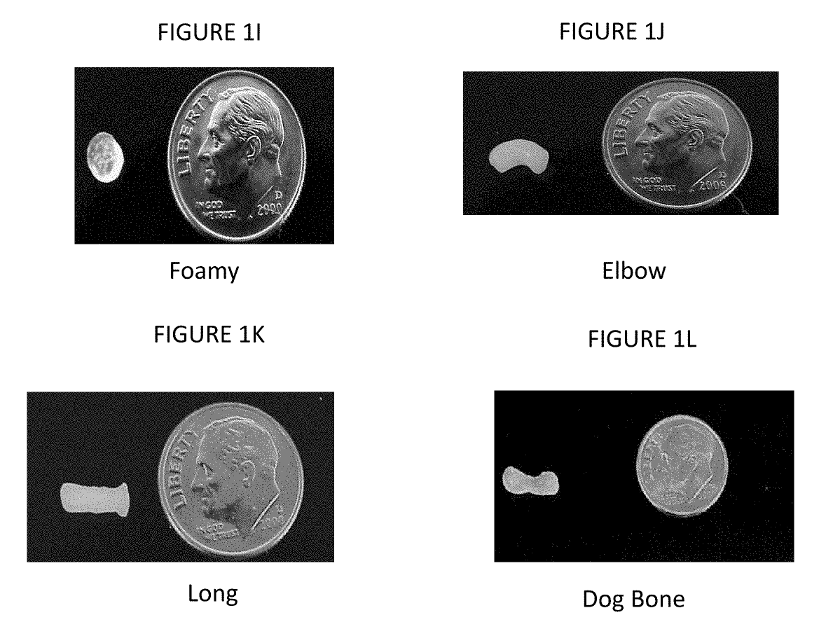

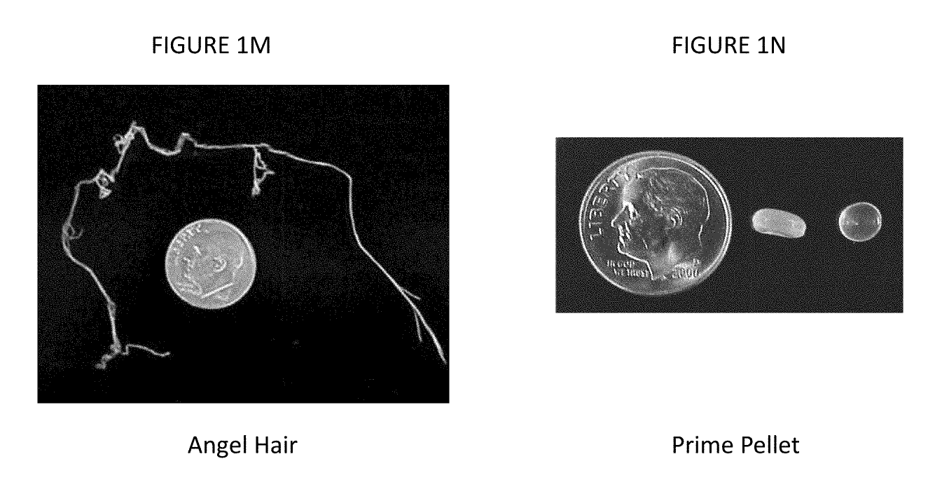

In certain embodiments, the process may be characterized by a reduction in the production of marginal and off-grade pellets in comparison to a process in which the metallic acrylic salt is not added (e.g., an otherwise identical process in which the metallic acrylic salt is not added). As used herein “prime pellets” refers to generally spherical pellets of a generally uniform size. As used herein, “marginal and off-grade pellets” may include pellets that are not generally spherical, not of a generally uniform size, or combinations thereof. For example and without limitation, marginal and off-grade pellets may include long pellets, big pellets, pellets of non-uniform size (e.g. chunks), pellets having a tail, clusters of pellets, chains of pellets, smeared pellets, smashed pellets, die freeze pellets, foamy pellets, elbows, angel hair, dog bones, or combinations thereof, as depicted in FIGS. 1A-1N. A United States 10 cent coin (dime) is depicted in FIGS. 1A-1N for perspective. In the depiction of a prime pellet at FIG. 1N, the prime pellet is depicted on the right side of the image, a dime is depicted on the left side of the image, and a big pellet is depicted in the center of the image for perspective. Long pellets include pellets that are longer in at least one direction than prime pellets. Big pellets are pellets that may be generally spherical, but are larger in diameter than a desired size for the prime pellets. Pellets of non-uniform size include any pellets not of a generally uniform size, such as chunks. Pellets having a tail are pellets that have a protrusion on an edge of the pellet that is small relative to the pellet. Clusters of pellets are groupings of pellets stuck together. Smeared pellets are pellets having a generally flattened and smeared shape relative to the generally spherical shape of the prime pellets. Dog bones are pellets generally having the shape of a dog bone. Chains of pellets include two or more pellets connected by a relatively thin “link” of polymeric material. Smashed pellets include pellets that have been smashed. Die freeze pellets include pellets that have solidified in the die hole. Elbows include pellets having the general shape of an elbow or macaroni. Foamy pellets include pellets containing gaseous bubbles or voids. Angel hair includes thin strands of polymeric material not in the form of pellets. In some embodiments, whether or not a pellet is a prime pellet, a marginal pellet, or an off-grade pellet may be determined by visual inspection.

Without being bound by theory, it is believed that contact of the metallic acrylic salt with the polyolefin lowers the melt flow rate of the polyolefin. In some embodiments, the polyolefin composition resulting from the contact of the metallic acrylic salt and polyolefin has a melt flow rate, as measured according to ASTM D 1238 standard at 230° C. under a load of 2.16 kg, at least 10% lower, at least 25% lower, at least 50% lower, at least 75% lower or at least 85% lower than the melt flow rate of the polyolefin prior to being contacted with the metallic acrylic salt. For example and without limitation, a polyolefin having melt flow rate of 100 g/10 min. may be used to form a polyolefin composition having a melt flow rate of 90 g/10 min. (i.e., 10% lower) by contact of the polyolefin with metallic acrylic salt. Without being bound by theory, it is believed that the addition of metallic acrylic salt to the polyolefin allows for the pelletization of polyolefins (e.g., polypropylene or polyethylene) with higher melt flow rates than would be possible if attempting to pelletize a polyolefin with the same melt flow rate without addition of the metallic acrylic salt.

In some embodiments, the pellets formed by the process disclosed herein may be processed to make an article, such as by methods known to those of ordinary skill in the art. For example and without limitation, the pellets may be processed by injection molding, fiber extrusion, film extrusion, sheet extrusion, pipe extrusion, blow molding, rotomolding, slush molding, injection-stretch blow molding or extrusion-thermoforming to produce the article. The article may be a container, fiber, film, sheet, pipe, packaging such as thin-walled packaging, or household article, for example.

In some embodiments, the process includes compounding the pelletized polyolefin composition with one or more additional polymers, one or more additives, or combinations thereof. The one or more additional polymers may include polyolefins as disclosed herein, polylactic acid, styrenic polymers, or combinations thereof. The one or more additives may include any of the additives disclosed herein. For example and without limitation, the compounding may be performed using mixing equipment including, but not limited to, a single or twin screw extruder, a BANBURY® mixer, or a roll mill.

### Increased Production Rate of Low Melt Flow Rate Polyolefins

In some embodiments, the polyolefin composition has a production rate that is equal to or greater than a production rate of the polyolefin prior to contact with the metallic acrylic salt without having to increase extrusion pressure or motor amperes used during extrusion and pelletization, notwithstanding the final lower melt flow rate of polyolefin composition in comparison to the melt flow rate of the polyolefin prior to contact with the metallic acrylic salt. As used herein, “production rate” refers to the amount in weight of polyolefin or polyolefin composition that is extruded and pelletized per unit of time. Without being bound by theory, it is believed that increased extrusion pressure and/or motor amperes are required in extrusion of polyolefins having a low melt flow rate (e.g., a melt flow rate of 4.0 g/10 min or less) in comparison to the extrusion of polyolefins having a high melt flow rate (e.g., a melt flow rate of greater than 4.0 g/10 min). Without being bound by theory, it is believed that addition of metallic acrylic salt to polyolefin may decrease the melt flow rate of the polyolefin, without reducing the production rate of the polyolefin composition in comparison to the production rate of the polyolefin without the metallic acrylic salt. For example and without limitation, if extrusion and pelletization of the polyolefin has a production rate of pellets equal to ‘X’ when extrusion and pelletization is operated at a particular extrusion pressure and motor amperes, then extrusion and pelletization of the polyolefin composition will have a production rate of pellets of equal to or greater than ‘X’ when extrusion and pelletization is operated at the same particular extrusion pressure and motor amperes.

Production rate may be expressed as “alpha rate.” As used herein, “alpha rate” refers to the ratio of the production rate of pellets of a resin relative to the production rate of pellets of a reference resin, wherein the reference resin is assigned an alpha rate of “1.” In some embodiments, a polyolefin with an alpha rate of 0.85 or greater, 0.90 or greater or 0.95 or greater, may be used to form a polyolefin composition having a relatively lower melt flow rate, while maintaining the relatively high alpha rate. For example and without limitation, a polyolefin having a relatively high alpha rate of 0.95 and a relatively high melt flow rate may be contacted with metallic acrylic salt, resulting in a polyolefin composition having the same relatively high alpha rate of 0.95, but with a melt flow rate that is lower than the polyolefin prior to contact with the metallic acrylic salt.

In certain embodiments, after addition of the metallic acrylic salt, and after extrusion and pelletization of the polyolefin composition, the process includes forming an article from the pelletized polyolefin composition. Articles that may be formed from the pelletized polyolefin composition include, but are not limited to, pipes, strapping, and foamed articles. Articles may be formed from the pelletized polyolefin composition by methods known to those of ordinary skill in the art including, but not limited to, extrusion, injection molding, blow molding or thermoforming.

### Steady State Pelletization of Polyolefin—High Melt Flow Rate Polyolefins

Without being bound by theory it is believed that adding the metallic acrylic salt to the polyolefin results in a polyolefin composition having increased melt elasticity relative to the melt elasticity of the polyolefin without the metallic acrylic salt. In some such embodiments, the increased melt elasticity may occur concurrently with a decrease in melt flow rate of the polyolefin, allowing for pelletization of polyolefins with higher melt flow rates (i.e., by decreasing the melt flow rate of the polyolefin) than would otherwise be possible without addition of the metallic acrylic salt.

In some embodiments, the polyolefin that is contacted with the metallic acrylic salt to form the polyolefin composition, which is subsequently extruded and pelletized, is a reactor grade polyolefin. The process may include contacting the reactor grade polyolefin with the metallic acrylic salt to form the polyolefin composition. In certain embodiments, the polyolefin used to form the polyolefin composition is not a vis-broken polyolefin.

In some embodiments, the polyolefin that is contacted with the metallic acrylic salt to form the polyolefin composition, which is subsequently extruded and pelletized, is a vis-broken polypropylene. As is known to those of ordinary skill in the art, vis-broken polypropylene may be formed by melt-compounding a polyolefin with a free radical generator. The melt-compounding may be performed by melt extrusion in an extruder, such as a single or twin screw extruder, for example. The free radical generator may include peroxide, such as organic peroxide. Examples of free radical generators include 3,6,9-triethyl-3,6,9-trimethyl-1,4,7-triperoxonane, commercially available from AKZONOBEL® under the tradename TRIGONOX® 301; and 2,5-bis(tert-butylperoxy)-2,5-dimethylhexane, commercially available from AKZONOBEL® as LUPERSOL™ 101. Vis-breaking polypropylene results in degradation of the polyolefin. The vis-broken polypropylene may have a deceased weight average molecular weight (Mw) or increased melt flow rate relative to the polyolefin prior to degradation of the polymer. During vis-breaking, the polypropylene may react with the free radical generator, during which polymer molecule scission occurs, resulting in an overall lowered molecular weight or elevated melt flow rate.

Without being bound by theory, it is believed that vis-broken polypropylenes have a greater tendency towards pelletization defects including, but not limited to formation of chains and tails. It is further believed that increased levels of vis-breaking leads to increased levels of such pelletization defects, as vis-breaking results in a loss of melt elasticity. Without being bound by theory, it is believed that addition of metallic acrylic salt to a vis-broken polypropylene results in increased melt elasticity relative to the melt elasticity of the vis-broken polypropylene without the metallic acrylic salt. In some such embodiments, the increased melt elasticity may allow for pelletization of polypropylene subjected to increased levels of vis-breaking than would otherwise be possible without addition of the metallic acrylic salts. As used herein, “levels of vis-breaking” refers to the number of polymer molecule scission that have occurred during vis-breaking. In some embodiments, vis-broken polypropylene contacted with metallic acrylic salt may be used to produce an increased rate of prime pellets relative to the rate of prime pellets produced by the same vis-broken polypropylene having the same level of vis-breaking, but without addition of the metallic acrylic salt.

In some embodiments, the process includes forming an article from the pelletized polyolefin composition. For example and without limitation, the article may include melt blown fibers. In certain embodiments, the article is a melt blown nonwoven. For example and without limitation, in melt blown processing, the pellets of the polyolefin composition may be melted in an extruder and then extruded through capillaries of a melt blowing die, which may have a single line of circular capillaries through which the molten polyolefin composition passes. After exiting from the die, the still molten filaments may be contacted with air, which draws the fibers and solidifies the filaments. A nonwoven may be formed by depositing such filaments onto a forming wire or a porous forming belt, for example.

In some embodiments, the process includes compounding the pelletized polyolefin composition. For example and without limitation, the pelletized polyolefin composition may be compounded with one or more additional polymers, one or more additives, or combinations thereof, as described herein.

### Steady State Pelletization of Polyolefin—Narrow Molecular Weight Distribution Polyolefin

In some embodiments, the polyolefin that is contacted with the metallic acrylic salt to form the polyolefin composition, which is subsequently extruded and pelletized, is a polyolefin having a molecular weight distribution (M_{w}/Mₙ) of 6.0 or less; 5.5 or less; 5.0 or less; 4.5 or less; 4.0 or less; 3.0 or less; or from 1.5 to 6.0, for example. M_{w} is the weight average molecular weight of the polyolefin, and Mₙ is the number average molecular weight of the polyolefin.

In certain embodiments, the polyolefin is a metallocene-catalyzed isotactic polyolefin (e.g., polypropylene). As used herein, “isotactic” polyolefin refers to a polyolefin with all or a majority of its pendant groups arranged on the same side of the chain.

Without being bound by theory, it is believed that polyolefins with a molecular weight distribution of 6.0 or less, such as metallocene-catalyzed isotactic polypropylenes (miPP), have a lower melt strength relative to polyolefins (e.g., polypropylenes) having the same melt flow rate but a broader molecular weight distribution, such as Ziegler-Natta-catalyzed isotactic polypropylenes. It is believed that addition of the metallic acrylic salt to such polyolefins allows for pelletization of such polyolefins (e.g., miPP) with a higher melt flow rate than would otherwise be possible without the addition of metallic acrylic salts.

### Transient Pelletization of Polyolefin

In some embodiments, the polyolefin is only contacted with the metallic acrylic salt to form the polyolefin composition during start-up of an extruder and pelletizer. In some embodiments, the polyolefin is not contacted with the metallic acrylic salt after start-up of the extruder and pelletizer. In certain embodiments, the process includes, during start-up of the extruder and pelletizer, extruding the polyolefin composition containing the metallic acrylic salt and the polyolefin, and pelletizing the extruded polyolefin composition. The polyolefin may be contacted with the metallic acrylic salt to form the polyolefin composition during an entirety of the start-up of the extruder and pelletizer, or only during a portion of the start-up of the extruder and pelletizer.

As used herein, “during start-up” of the extruder and pelletizer refers to a period of time during which the extruder and pelletizer are brought from shutdown conditions to steady-state conditions. As used herein, “shutdown conditions” refers to the state of the extruder and pelletizer when the extruder and pelletizer are not being used to extrude or pelletize material. As used herein, “steady-state conditions” refers to the state of the extruder and pelletizer when the extruder and pelletizer are being used to extrude and pelletize material, and when extrusion and pelletization conditions (e.g., temperature, pressure and motor amperes) are stable and at the desired production rate. During start-up, the extruder may be brought to a temperature at which the material being extruded and pelletized becomes molten, and the rotation of the screw(s) of the extruder may be brought from a state of no rotation to a state of rotation suitable for extrusion of the material (e.g., a state of rotation that provides a pressure sufficient for extrusion of the material).

In some embodiments, the polyolefin composition extruded and pelletized during start-up of the extruder and pelletizer is discarded. In some embodiments, the polyolefin composition extruded and pelletized during start-up of the extruder and pelletizer is not discarded. For example and without limitation, the polyolefin composition extruded and pelletized during start-up of the extruder and pelletizer may be collected, separate from or together with the polyolefin extruded and pelletized after start-up of the extruder and pelletizer is complete, for sale or use (e.g., article forming processes).

The process may include, after the start-up of the extruder and pelletizer is complete, when steady-state conditions of the extruder and pelletizer are reached, extruding the polyolefin without further addition of the metallic acrylic salt to the extruder and pelletizer, and pelletizing the extruded polyolefin without further addition of the metallic acrylic salt to the extruder and pelletizer. In some embodiments, the polyolefin extruded and pelletized after the start-up of the extruder and pelletizer is complete contains metallic acrylic salt for a period of time after the start-up of the extruder and pelletizer is complete (e.g., due to residual metallic acrylic salt added during start-up). In some such embodiments, the amount of metallic acrylic salt present in the extruded and pelletized polyolefin after the start-up of the extruder and pelletizer is complete reduces over time. In some embodiments, a point in time is reached after the start-up of the extruder and pelletizer is complete at which the polyolefin extruded and pelletized does not contain any metallic acrylic salt.

In some such embodiments, the polyolefin is a metallocene-based polyolefin (e.g., a metallocene-based isotactic polypropylene). In certain embodiments, the metallocene-based isotactic polyolefin (e.g., polypropylene) has a melt flow rate of greater than 20.0 g/10 min or greater than 24 g/10 min as measured according to ASTM D 1238 standard at 230° C. under a load of 2.16 kg.

In some embodiments, the polyolefin (e.g., metallocene-based isotactic polypropylene) is a reactor grade polyolefin. For example and without limitation, in certain embodiments the polyolefin is not a vis-broken polypropylene.

The process may include forming an article from the pelletized polyolefin that is extruded and pelletized after the start-up of the extruder and pelletizer is complete. For example and without limitation, the article may be an injection molded article formed by injection molding or a fiber (e.g., a fiber formed by extrusion, spinning, or melt blown processing).

The process may include compounding the pelletized polyolefin that is extruded and pelletized after the start-up of the extruder and pelletizer is complete with one or more additional polymers, one or more additives, or combinations thereof, as described herein.

In some embodiments, addition of the metallic acrylic salt to the polyolefin during the startup of the extruder and pelletizer reduces fouling of the extruder and pelletizer. As used herein, “fouling” refers to the accumulation of material (e.g., polyolefin deposits) on the surfaces within the extruder and/or pelletizer.

In some embodiments, the process does not include, during start-up, extruding and pelletizing a polymer different than the polyolefin extruded after start-up is complete. In some embodiments, the polyolefin contacted with the metallic acrylic salt and extruded and pelletized during start-up is the same polyolefin that is extruded and pelletized after start-up is complete.

Without being bound by theory, traditionally it has been thought that reactor grade resins, such as metallocene isotactic polypropylenes (miPP) with melt flow rates of 20 g/10 min. or greater might present challenges during start-up of an extruder and pelletizer. Without being bound by theory, it is believed that the addition of metallic acrylic salt to such polyolefins allows for pelletization during the start-up by increasing melt elasticity and reducing melt flow rate, and once steady-state conditions are reached the presence of the metallic acrylic salt may no longer be needed for pelletization. In some embodiments, the addition of the metallic acrylic salt to the polyolefin during the start-up reduces the production of marginal and off-grade pellets, and increases the yield of prime pellets.

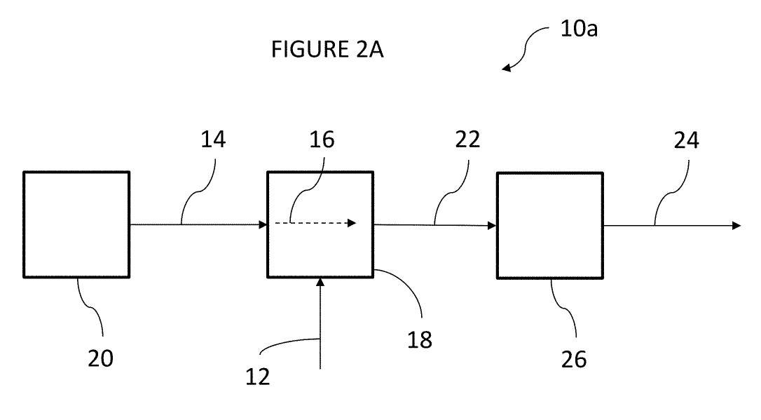

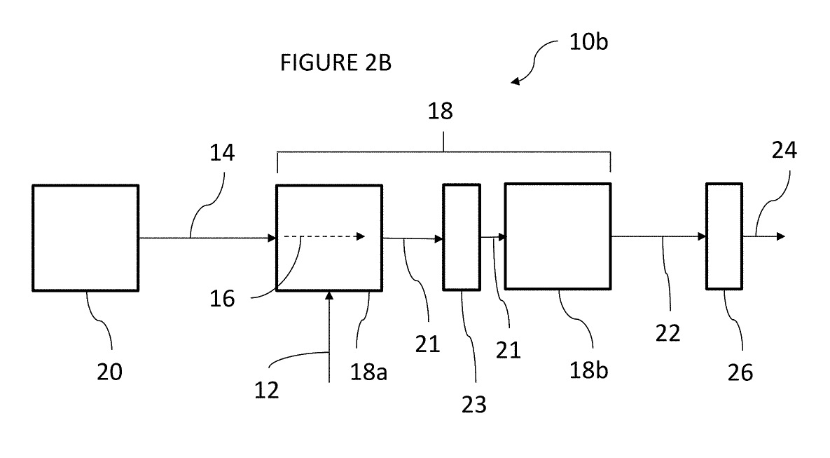

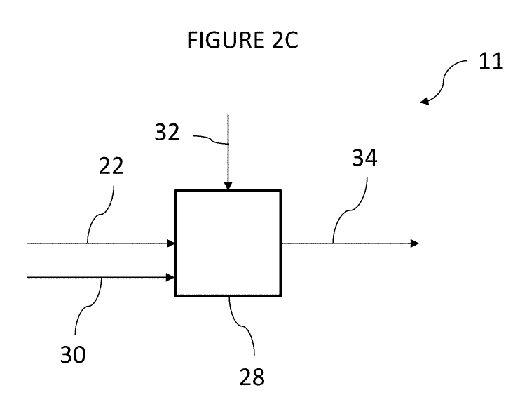

FIG. 2A is a flow diagram of process 10a in accordance with certain embodiments, and FIG. 2B is a flow diagram of process 10b in accordance with certain embodiments.

With reference to both FIGS. 2A and 2B, metallic acrylic salt 12 may be contacted with polyolefin 14, forming polyolefin composition 16. For example and without limitation, metallic acrylic salt 12 may be contacted with polyolefin 14 within extruder and pelletizer 18. While depicted as being input separately into extruder and pelletizer 18, metallic acrylic salt 12 and polyolefin 14 may be input into extruder and pelletizer 18 as a single stream. For example and without limitation, metallic acrylic salt 12 and polyolefin 14 may be compounded together prior to being input into extruder and pelletizer 18.

Process 10a, as shown in FIG. 2A, includes extruding polyolefin composition 16 from extruder and pelletizer 18, and pelletizing polyolefin composition 16 as extruded polyolefin composition 16 exits extruder and pelletizer 18, forming pellets 22.

In process 10b, as shown in FIG. 2B, extruder and pelletizer 18 includes extruder 18a, pelletizer 18b, and cooling section 23. Cooling section 23 may include, for example, a water bath. Process 10b includes extruding polyolefin composition 16 from extruder 18a, forming extrudate 21. Extrudate 21 may be in the form of strands of extruded polyolefin composition 16. Extrudate 21 may pass through cooling section 23. After passing through cooling section 23, extrudate 21 may have a lower temperature than prior to passing through cooling section 23. Process 10b includes pelletizing cooled extrudate 21 in pelletizer 18b, forming pellets 22.

With reference to both FIGS. 2A and 2B, in some embodiments, polyolefin 14 is a reactor grade polyolefin fed directly from polymerization reactor 20 into extruder and pelletizer 18 without intermediate processing, with the exception of optionally being compounded with metallic acrylic salt 12 upstream of extruder and pelletizer 18. In other embodiments, polyolefin 14 is not a reactor grade polyolefin. Polyolefin 14 may include polypropylene or polyethylene. In some embodiments, polyolefin 14 is an elastomer. In certain embodiments, polyolefin 14 is a vis-broken polypropylene. In some embodiments, polyolefin is a metallocene-catalyzed polyolefin (e.g., metallocene isotactic polypropylene or metallocene polyethylene) or a Ziegler-Natta-catalyzed polyolefin (e.g., polypropylene or polyethylene). In certain embodiments, polyolefin 14 has a molecular weight distribution (M_{w}/Mₙ) of 6.0 or less. In some embodiments, polyolefin 14 is a polypropylene impact copolymer.

In some embodiments, prior to contact with metallic acrylic salt 12, polyolefin 14 has a melt flow rate of greater than the melt flow rate of polyolefin composition 16, as measured according to ASTM D 1238 standard at 230° C. under a load of 2.16 kg. Without increasing extrusion pressure or motor amperes, processes 10a and 10b may exhibit a production rate of pellets 22 of the polyolefin composition 16 that is equal to a production rate of an otherwise equivalent process in which polyolefin 14 is extruded and pelletized using the same extrusion pressure or motor amperes without contact with metallic acrylic salt 12.

Processes 10a and 10b may include forming article 24 from pellets 22. For example and without limitation, pellets 22 may be processed in article forming unit 26 (e.g., an injection mold or extruder) to form article 24. In some embodiments, article 24 is a pipe, strapping, a foamed article, melt blown fibers, or a melt blown nonwoven. In some embodiments, forming article 24 includes subjecting pellets to injection molding, extrusion, blow molding or thermoforming processing.

In certain embodiments of processes 10a and 10b, metallic acrylic salt 12 is only contacted with polyolefin 14 to form polyolefin composition 16 during a start-up of extruder and pelletizer 18. In such embodiments, after start-up of extruder and pelletizer 18 is complete, when steady-state conditions of extruder and pelletizer 18 are reached, process 10a and/or 10b includes extruding polyolefin 14 without further addition of metallic acrylic salt 12 to extruder and pelletizer 18, and pelletizing extruded polyolefin 14 without further addition of metallic acrylic salt 12 to extruder and pelletizer 18. In some such embodiments, polyolefin 14 is a reactor grade polyolefin that is not vis-broken, such as a reactor grade metallocene-based isotactic polypropylene having a melt flow rate of greater than 20.0 g/10 min as measured according to ASTM D 1238 standard at 230° C. under a load of 2.16 kg.

Process 10a and/or 10b may include forming article 24 from pelletized polyolefin 14 that is extruded and pelletized after start-up of extruder and pelletizer 18 is complete. In some such embodiments, article 24 is an injection molded article or a fiber.

With reference to FIG. 2C, pellets 22 formed in process 10a and/or 10b as depicted in FIGS. 2A and 2B, either with our without addition of metallic acrylic salts 12 after start-up is complete, may be subjected to compounding process 11. Pellets 22 may be compounded in compounder 28 with one or more additional polymers 30, one or more additives 32, or combinations thereof, as described herein. Compounder 28 may be an extruder, a BANBURY® mixer, or a roll mill, for example. Additional polymers 30 may include polyolefins as disclosed herein, polylactic acid, styrenic polymers (e.g., polystyrene), or combinations thereof. Additives 30 may include any of the additives disclosed herein. Compounding process 11 may produce compound composition 34. Compound composition 34 may be used to produce articles, as described herein.

### EXAMPLES

The disclosure having been generally described, the following examples show particular embodiments of the disclosure. It is understood that the example is given by way of illustration and is not intended to limit the specification or the claims. All compositions percentages given in the examples are by weight.

### Example 1

The relationship of melt flow rate reduction to the amount of the metallic acrylic salt added to a polyolefin resin was examined. For the polyolefin, a polypropylene homopolymer having a melt flow rate of 4.1 g/10 min. was used. For the metallic acrylic salt, zinc diacrylate DYMALINK® 9200, available from Total Cray Valley, was used. Some typical properties of DYMALINK® 9200 are listed in Table 1.

TABLE 1
Properties of DYMALINK ® 9200

| Property | Value |
|---|---|
| Appearance | White powder |
| Molecular weight | 207 |
| Moisture, ppm | 0-4500 |
| Specific gravity, g/ml | 1.64-1.72 |

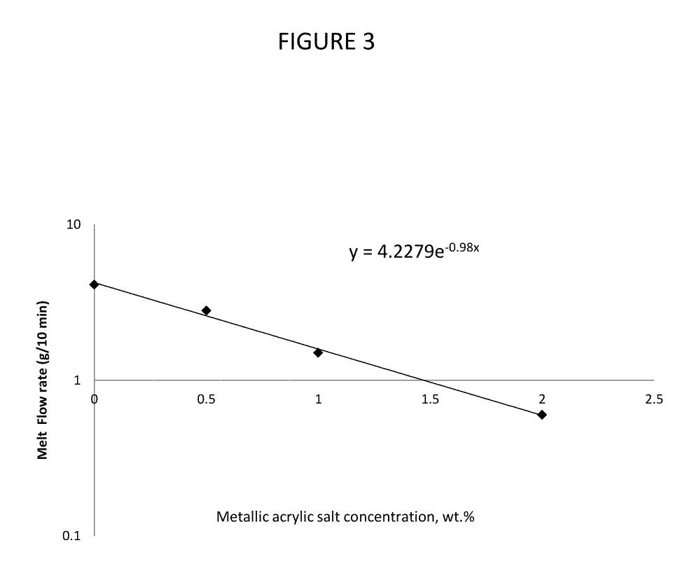

FIG. 3 is a graph of melt flow rate (g/10 min.) versus concentration (weight percent) of DYMALINK® 9200 based on a total weight of the polypropylene and the DYMALINK® 9200. In Example 1, melt flow rate was determined in accordance with ASTM D 1238 standard at 230° C. under a load of 2.16 kg.

### Example 2

The relationship of melt flow rate reduction to the amount of the metallic acrylic salt added to a polypropylene impact copolymer resin was examined. For the polypropylene impact copolymer, a base grade having a melt flow rate of 7.6 g/10 min. was used. For the metallic acrylic salt, zinc diacrylate (ZDA) DYMALINK® 9200, available from Total Cray Valley, was used.

Table 2 shows the melt flow rate (g/10 min.) versus concentration (weight percent) of DYMALINK® 9200 based on a total weight of the polypropylene and the DYMALINK® 9200. In Example 2, melt flow rate (MFR) was determined in accordance with ASTM D 1238 standard at 230° C. under a load of 2.16 kg.

TABLE 2
Relationship of MFR reduction to the
amount of zinc diacrylate (ZDA)

| ZDA concentration | MFR |
|---|---|
| [wt. %] | [g/10 min] |
| 0.0 | 7.6 |
| 0.5 | 5.8 |
| 1.0 | 3.8 |
| 2.0 | 1.6 |
| 4.0 | 0.8 |

With reference to Table 2, 0.5 weight percent of DYMALINK® 9200 was added to the based polypropylene impact copolymer based on a total weight of DYMALINK® 9200 and the base polypropylene and a polyolefin composition having a melt flow rate of 5.8 g/10 min was obtained while maintaining production rate. Also, 1.0 weight percent of DYMALINK® 9200 was added to the based polypropylene impact copolymer based on a total weight of DYMALINK® 9200 and the base polypropylene and a polyolefin composition having a melt flow rate of 3.8 g/10 min was obtained while maintaining production rate. Also, 2.0 weight percent of DYMALINK® 9200 was added to the based polypropylene impact copolymer based on a total weight of DYMALINK® 9200 and the base polypropylene and a polyolefin composition having a melt flow rate of 1.6 g/10 min was obtained while maintaining production rate. Also, 4.0 weight percent of DYMALINK® 9200 was added to the based polypropylene impact copolymer based on a total weight of DYMALINK® 9200 and the base polypropylene and a polyolefin composition having a melt flow rate of 0.8 g/10 min was obtained while maintaining production rate.

Without being bound by theory, it is believed that extrusion and pelletization of a higher melt flow rate (and higher alpha rate) resin with the addition of a metallic acrylic salt, instead of extrusion and pelletization of a lower melt flow rate (and lower alpha rate) resin without metallic acrylic salt, will result in an increased production rate of prime pellets.

Depending on the context, all references herein to the “disclosure” may in some cases refer to certain specific embodiments only. In other cases it may refer to subject matter recited in one or more, but not necessarily all, of the claims. While the foregoing is directed to embodiments, versions and examples of the present disclosure, which are included to enable a person of ordinary skill in the art to make and use the disclosures when the information in this patent is combined with available information and technology, the disclosures are not limited to only these particular embodiments, versions and examples. Other and further embodiments, versions and examples of the disclosure may be devised without departing from the basic scope thereof and the scope thereof is determined by the claims that follow.

What is claimed is:

1. A process comprising:
contacting a metallic acrylic salt with a polyolefin to form a polyolefin composition;
extruding the polyolefin composition; and
pelletizing the extruded polyolefin composition, wherein the polyolefin composition has a melt flow rate, as measured according to ASTM D 1238 standard at 230° C. under a load of 2.16 kg, that is lower than the melt flow rate of the polyolefin prior to contact with the metallic acrylic salt.

2. The process of claim 1, further comprising forming an article from the pelletized polyolefin composition.

3. The process of claim 2, wherein the article comprises a pipe, strapping, or a foamed article.

4. The process of claim 2, wherein the forming comprises extrusion, injection molding, blow molding or thermoforming.

5. The process of claim 1, further comprising compounding the pelletized polyolefin composition with one or more additional polymers, one or more additives, or combinations thereof.

6. The process of claim 1, wherein the metallic acrylate salt is zinc diacrylate, zinc dimethylacrylate, copper diacrylate, copper dimethylacrylate. zinc di-vinylacetate, zinc di-ethylfumarate, copper di-vinylacetate, copper diethylefumarate, aluminum triacrylate, aluminum trimethylacrylate, aluminum tri-vinylacetate, aluminum tri-ethylfumarate, zirconium tetraacrylate, zirconium tetramethylacrylate, zirconium tetra-vinylacetate, zirconium tetra-ethyl fumarate, sodium acrylate, sodium methacrylate, silver methacrylate, or combinations thereof.

7. The process of claim 1, wherein the metallic acrylate salt is zinc diacrylate.

8. The process of claim 1, wherein the polyolefin is a reactor grade polyolefin.

9. The process of claim 8, further comprising forming an article from the pelletized polyolefin composition.

10. The process of claim 1, wherein the polyolefin is a vis-broken polyolefin.

11. The process of claim 10, further comprising forming an article from the pelletized polyolefin composition.

12. The process of claim 11, wherein the article comprises a melt blown nonwoven.

13. The process of claim 1, wherein the polyolefin is a metallocene-catalyzed isotactic polypropylene.

14. The process of claim 1, wherein the polyolefin has a molecular weight distribution (M_{w}/Mₙ) of 6.0 or less.

15. The process of claim 1, wherein the polyolefin is a Ziegler-Natta-catalyzed isotactic polypropylene.

16. The process of claim 1, wherein the polyolefin is a polypropylene impact copolymer.

17. The process of claim 1, wherein the polyolefin is polypropylene or polyethylene.

18. The process of claim 1, wherein the polyolefin is a metallocene-catalyzed polyethylene.

19. The process of claim 1, wherein the polyolefin is an elastomer.

20. A pellet formed by the process of claim 1.

21. A process comprising:
contacting a metallic acrylic salt with a polyolefin, forming a polyolefin composition;
extruding the polyolefin composition; and
pelletizing the extruded polyolefin composition, wherein the metallic acrylic salt is only contacted with the polyolefin to form the polyolefin composition during a start-up of an extruder and pelletizer.

22. The process of claim 21, wherein, after the start-up of the extruder and pelletizer is complete, when steady-state conditions of the extruder and pelletizer are reached, the process further comprises:
extruding the polyolefin without further addition of the metallic acrylic salt to the extruder and pelletizer; and
pelletizing the extruded polyolefin without further addition of the metallic acrylic salt to the extruder and pelletizer.

23. The process of claim 21, wherein the polyolefin is a metallocene-based isotactic polypropylene having a melt flow rate of greater than 20.0 g/10 min as measured according to ASTM D 1238 standard at 230° C. under a load of 2.16 kg.

24. The process of claim 21, wherein the polyolefin is not a vis-broken polyolefin.

25. The process of claim 21, further comprising forming an article from the pelletized polyolefin that is extruded and pelletized after the start-up of the extruder and pelletizer is complete.

26. The process of claim 25, wherein the article is an injection molded article or a fiber.

27. The process of claim 21, further comprising compounding the pelletized polyolefin that is extruded and pelletized after the start-up of the extruder and pelletizer is complete with one or more additional polymers, one or more additives, or combinations thereof.

28. A pellet formed by the process of claim 21.

29. A process comprising:
contacting a metallic acrylic salt with a polyolefin to form a polyolefin composition;
extruding the polyolefin composition; and
pelletizing the extruded polyolefin composition, wherein a production rate of pellets of the polyolefin composition is equal to or greater than a production rate of pellets of the polyolefin prior to contact with the metallic acrylic salt without increasing extrusion pressure or motor amperes.

30. The process of claim 29, wherein the production rate of pellets of the polyolefin composition is equal the production rate of pellets of the polyolefin prior to contact with the metallic acrylic salt without increasing extrusion pressure or motor amperes.

31. The process of claim 29, wherein the production rate of pellets of the polyolefin composition is greater than the production rate of pellets of the polyolefin prior to contact with the metallic acrylic salt without increasing extrusion pressure or motor amperes.

32. A pellet formed by the process of claim 29.
